(19) United States
(12) Patent Application Publication
(10) Pub. No.: US 2007/0073684 A1
(43) Pub. Date: Mar. 29, 2007

(54) Retrieving information items from a data storage

(75) Inventor: Warner Rudolph Theophile Ten Kate, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/580,056

(22) PCT Filed: Nov. 11, 2004
(86) PCT No.: PCT/IB04/52378

§ 371 Date: May 22, 2006

(30) Foreign Application Priority Data
Nov. 25, 2003 (EP) 03104354.0

(51) Int. Cl. G06F 17/30

(52) U.S. Cl. 707/6

(57) ABSTRACT

The invention relates to a method of retrieving a plurality of information items from a data storage, the method comprising: submitting a request to the data storage, the request comprising a general classification; retrieving the plurality of information items of which at least a predefined amount of the plurality of information items complies with the general classification and wherein the general classification defines a first class and the plurality of information items are elements of a second class and there exists a subsumption relation between the first and second class. The invention further relates to a system (300) for retrieving a plurality of information items from a data storage, the system comprising: submitting means (306) conceived to submit a request to the data storage, the request comprising a general classification; classification means (312) conceived to define a first class and a second class, wherein the general classification defines the first class, and wherein the plurality of information items are elements of the second class and there exists a subsumption relation between the first and second class; retrieving means (308) conceived to retrieve the plurality of information items of which at least a predefined amount of the plurality of information items complies with the general classification.

The invention further relates to a system for retrieving a plurality of information items from a data storage.

The invention further relates to a computer program product designed to perform such a method.

The invention further relates to an information carrier comprising such a computer program product.

Networked connectivity, and the Internet in particular, has brought a new paradigm of accessing media. Next to the delivery and playback of traditional content, it is also feasible to combine media into new, interactive multimedia presentations. In order to benefit from the new opportunities while engaging in social activities, support is needed to navigate efficiently to the appropriate content. The navigation is increasingly challenged with the increasing size of available content, the heterogeneity of content types, and the scale of distribution. Even tracing back some piece of content can be cumbersome. Keyword search alone seems not adequate enough, as it requires the user to browse through the possibly lengthy responses and to creatively modify the entered keyword sequences to find the content of interest.

Technically, the problem relates to the mismatch between the system which operates at the syntactical level, while the user's cognition is at the semantic level. An approach to bridge this gap would be the introduction of semantics in the machine processes, such that the system “understands” user meaning, intentions and situations, as well as “understands” what kind of experiences content may cause when exposed to its users. The Semantic Web development, headed at the World Wide Web Consortium (W3C), introduces a framework of languages that can help in making this type of interpretation happen, see W3C, The Semantic Web, on http://www.w3.org/2001/sw/. In particular, the currently being developed languages Resource Description Framework (RDF), and Web Ontology Language (OWL) see “Resource Description Framework (RDF) Model and Syntax Specification, W3C REC, http://www.w3.org/TR/REC-rdf-syntax/, February 1999” and “OWL Web Ontology Language—Semantics and Abstract Syntax, W3C CR, http://www.w3.org/TR/owl-absyn/, August 2003”. A rule language is expected in the future.

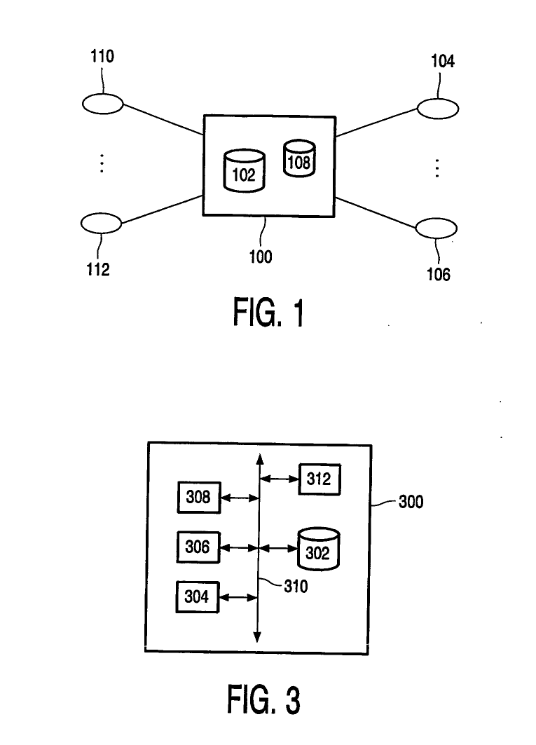

FIG. 1 illustrates a system that provides an ontology. The system 100 comprises an ontology 102 and one or more mappings 108. The system is connected to m content providers 104 to 106. The mapping 108 maps user preferences and user queries of n users 110 to 112 to metadata of the m content providers 104 to 106. The mapping can be implemented in several ways. For example, it can be implemented as a table between user terminology and ontology, for each user a separate table, and a mapping between ontology and each provider. In its general meaning, ontology is the study or concern about what kinds of things exist in the world and how they are related. Here, an ontology is the specification of conceptualizations, used to help programs and humans share knowledge. In this usage, an ontology is a set of concepts—such as things, events, and relations—that are specified in some way (such as specific natural language) in order to create an agreed-upon vocabulary for exchanging information. The ontology may include descriptions of classes, properties and their elements, see “What's an ontology”, by Tom Gruber on http://www-ksl.stanford.edu/kst/what-is-an-ontology.html. The mapping can also be considered as a process modelled by the ontology, which relates a user concept to a provider concept through the knowledge provided by the ontology. In the latter case there is preferably one, possibly distributed, ontology per session.

A user chooses a provider, possibly through a portal and navigates the site of the provider or navigates to other sites of possibly other providers.

The system 100 should supply the n users with media content from the m different providers, where only content is selected that matches the user's preference profile. A first step in that direction is to use metadata about the content in the search and selection processes. For example, the content items can be classified according to the metadata they share. Hereto, the keywords denoting the metadata are preferably structured in a schema, upon which the search application can base its classification algorithm. It is unlikely that on the internet all users and providers will make use of one single metadata schema, albeit for the problem of maintaining the schema updated and shared consistently, not to mention the problem of incomplete or erroneous information. A second step, therefore, is to establish the ontology 102 that spans sufficiently the domains of user and provider, such that it can support the system 100, which maps user preferences and queries on the provider's metadata.

As previously described, an ontology describes an application domain in terms of concepts, also referred to as names, and roles, also referred to as relations, between those concepts. Concepts can be defined in terms of other concepts, using logic constructs as conjunction, disjunction and negation, as well as specifying restrictions on relationships with other classes. The semantics of the constructs is defined in a model theory, which includes the definition of the entailments or deductions that can be made. When using the part of OWL that conforms to Description Logic (DL, see F. Baader et al, The Description Logic Handbook, Cambridge, 2003) the search for these entailments can be offered as an independent service. An example entailment is to infer subsumption relations, also referred to as subclass relations, between concepts that are not explicitly modelled in the schema. In other words, a query asking for a certain type of concept, for example, a certain genre of music, might be incomplete or can be phrased in another way than that the elements in the database, in this case the music items, are classified. The inference service offers a means to decide whether the class of music items is a subclass of the requested class of music genre. This often requires that both the query and the database's classification use the same ontology language.

For example, assume that a provider offers music labeled “Evergreens”. The songs in the collection are annotated with title and artist name. For example, it includes “Yesterday”/“The Beatles” and “Bridge over Troubled Water”/“Simon and Garfunkel”. The user sets up his own preference list, creating a class called “Golden Hits”. Using the ontology, the class called “Golden Hits” is defined as containing songs that were “hits” (a first concept) in the “60s” (a second concept). Further assume there exists a site that publishes the weekly top ten listings. The ontology makes use of the site by defining its “hits” concept as the collection of items listed on that top-ten site. In addition, relations are established between the site's data fields and the ontology's concepts as “title”, “artist”, and “compositionDate”. Finally, the ontology defines the concept “60s” in terms of its concept “compositionDate”. Additional relations with the same site or with other repositories determine the element values.

Thus, the user preference lists class “Golden Hits” is known in terms of the ontology as “listed on top-ten site” and “composed in 60s”. The “Evergreens” class is known in the terms of the ontology as “collection of title/artist pairs”. Based on these class definitions, it can be determined whether “collection of title/artist pairs” is a subclass of “listed on top-ten site”, and, in a similar fashion, whether it is a subclass of “composed in 60s”. If so, it is a subclass of “Golden Hits” and the content is of interest to the user.

The ontology provides a mechanism to reason about classes, performing such functions as classification, testing membership, and finding most specific subsumer or superclass relations between classes. Classes can be defined intensionally, extensionally or as a combination of both. An intensionally defined class is defined in terms of restrictions and general relationships that must hold. An extensionally defined class is defined by enumerating the elements that are member of the class. This enumeration might be virtually infinite. An extensionally defined class, in general, does not provide for a semantic definition of the class. It is by inspection that the computing device, such as a computer server, has to derive such a semantic definition or classification of the class's signature. Also, upon instantiating the class with music items the human may enter items that do not strictly, in the sense of the semantic definition, belong to the class. If in the enumeration one or a few of such outlier elements occur they cause the signature of the class to broaden and in the computing devices' reasoning the class may loose its subclass relation to the other class. In the example, if in the collection “Evergreens” there is one song that is composed in 1959 or 1970, the system would conclude that “Evergreens” is no longer a subclass of “Golden Hits”. The user would not be presented with the songs from “Evergreens”, while they match the interests or intentions of the user.

If “Evergreens” was defined intensionally, then, upon entering the exceptional song in the database, the computing device that is connected to the database, could signal the inconsistency in the class membership, presumed that the intensional definition is such that the song is exceptional indeed.

An embodiment of a system and method according to the opening paragraph is disclosed in “Fuzzy generalization hierarchies for ontology-driven attribute-oriented induction in data mining”, by Rafal A. Angryk, (on http://www.humaniora.sdu.dk/ifki/ontoquery/projects/Project_Rafal_Angrvk.pdf, retrieved 21 Jun. 2003). Here, a fuzzy ontology-driven generalization hierarchy is described in order to classify data hierarchically. The data to be classified is stored into databases and can have a partial membership in two or more higher level concepts. For example, in the case of colours: white, grey and black, a first level concept can distinguish between: light achromatic colour and dark achromatic colour. A second level concept is then achromatic colour. Now, light achromatic is modelled as a 100% subclass of achromatic colour and dark achromatic colour is also modelled as a 100% subclass of achromatic colour. Next, the colour white is a 100% subclass of light achromatic colour, the colour grey is a 50% subclass of light achromatic colour and it is a 50% subclass of dark achromatic colour, and the colour black is a 100% subclass of dark achromatic colour. The percentages reflect partial membership of lower level values in the higher-level (generalized) values. With the introduction of the percentages, the relationship between lower level and higher-level values becomes fuzzy, allowing lower level values to be a member of more than one higher-level concept. A request for light achromatic colours thus results in the retrieval of both white and grey colours even though only grey is defined as being 50% light achromatic. Changing the composition of grey results in changing the member percentages for the higher level concepts such that grey remains a member of the higher-level concepts light and dark achromatic colour.

It is an object of the invention to provide a method according to the opening paragraph that retrieves the plurality of information items in an improved way. In order to achieve this object, the method comprises: submitting a request to the data storage, the request comprising a general classification; retrieving the plurality of information items of which at least a predefined amount of the plurality of information items complies with the general classification, the general classification defining a first class and the plurality of information items are elements of a second class and there exists a subsumption relation between the first and second class. By requiring that at least a predefined amount of the plurality of information items complies with the general classification, it is allowed that the second class also comprises information items that do not comply with the general classification that defines the first class. As a result, information items can be retrieved from the data storage that do not strictly comply with the request. As an example of a subsumes relation, let Class A be the first class, and Class B be the second class, then Class A subsumes Class B indicates that Class B is a subset of Class A, i.e. Class B⊂Class A.

An embodiment of the method according to the invention is described in claim 2. By defining the elements of the second class extensionally by enumerating each information item of the plurality of information items, a computing device can derive a general classification that defines the first class and its relationship with the second class. The computing device can maintain the relationship between the first class and the second class even though the second class comprises information items that do not comply with the general classification.

An embodiment of the method according to the invention is described in claim 3. By removing the information items from the class that do not comply with the general classification, general reasoning rules can be applied to the first and the second class and the elements they comprise. Such general reasoning rules are for example defined within Description Logic (DL).

An embodiment of the method according to the invention is described in claim 4. By defining that the plurality of information items is a subset of a second plurality of information items implies that at least a predefined amount of the plurality of information items is a subset of the second plurality of information items, reasoning rules can be defined for the computing device to reason about relations between classes. Other reasoning rules, like conjunction, disjunction and negation can be defined analogously.

An embodiment of the method according to the invention is described in claim 5. By defining the predefined amount as one of a percentage of the plurality of information items or an absolute number of the plurality of information items, the computing device can apply rules for defining the relationship between a first class and a second class.

An embodiment of the method according to the invention is described in claim 6. By adding the removed annotated information items to the query result, i.e. to the retrieved information items, the information items that do not strictly comply to the query are retrieved too.

Further embodiments of the method according to the invention are described in claim 7 and 8.

It is an object of the invention to provide a system according to the opening paragraph that retrieves the plurality of information items in an improved way. In order to achieve this object, the system comprises: submitting means conceived to submit a request to the data storage, the request comprising a general classification; classification means conceived to define a first class and a second class, wherein the general classification defines the first class, and wherein the plurality of information items are elements of the second class and there exists a subsumption relation between the first and second class; retrieving means conceived to retrieve the plurality of information items of which at least a predefined amount of the plurality of information items complies with the general classification.

These and other aspects of the invention will be apparent from and elucidated with reference to the embodiments described hereinafter as illustrated by the following Figures:

FIG. 1 illustrates a system that provides an ontology;

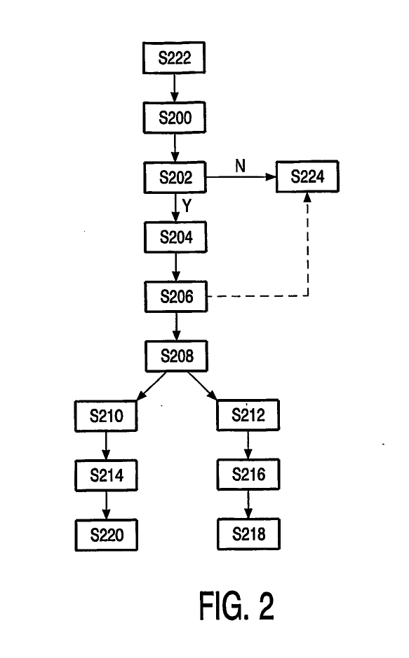

FIG. 2 illustrates an embodiment of the main steps of the method according to the invention;

FIG. 3 illustrates an embodiment of a system according to the invention in a schematic way.

In order to allow reasoning about classes of which not all members do strictly belong to the class, the subclass relation is extended in a fuzzy form. The class definitions are extended with a statistical number, such as a percentage, that indicates what percentage of members from another class_may not be member according to the class definition to still identify the other class as a subclass. The other way around is also possible: a statistical number that indicates what percentage of members from the current class_may not be member according to the class definition to still identify the other class as a superclass. The default value is 100%, preferably. Instead of using a percentage, an absolute number can be used. Members in an extensionally defined class that are outliers in this sense are considered as fuzzy members of that class, hence “defining” the fuzzy class membership function. In terms of the semantics, the subsumption relation is to be interpreted as the fuzzy subclass relation C⊂D. It's meaning is that if x is a member of C, then x is also a member of D, (xεC) [symbol] (xεD), where the membership relation ε is defined as fuzzy membership, i.e. the implication only needs to hold for the given percentage of members in C. Conjunction, disjunction and negation follow likewise: C∪D=D, C∩D=C, and [symbol] C=Δ−C.

The approach can also be applied in the case of partitioning, where a similar problem exists. For example, assume a concept “genre” which has been defined to consist of a range of types. An element of a music item is in one, and only one, of those types. Hence, the range of types form a partition of their superclass “genre”. Combinations of types are considered as types by themselves, and either a (granularity) level in the partition hierarchy is introduced, or the combined typed is considered a type by itself, excluding its members to be also member of one of the contributing types.

A user and a provider can classify the majority of music items in a similar way. However, there can also be exceptions which they will classify differently. Fuzzy membership can solve for this, while still keeping the notion of a partitioning. A music item belongs to one genre or one type as a subset of genre, while the intersection of the sets can be non-empty. Non-empty intersection can happen when a particular music item is classified differently by user and provider.

FIG. 2 illustrates an embodiment of the main steps of the method according to the invention. Within the first step S222 a user submits a query to a database server. The database server can be located remotely from where the user submits his query and the database itself can be distributed over the network. The database comprises the provider's metadata and the ontology, as previously described, can be located at again a different location. Also, the ontology can be distributed. In particular, according to the concepts of the Semantic Web, the ontology can consist of a conglomerate of different, and dynamically collected, ontologies. It is also possible that the particular providers and users involved change dynamically, at least on a session-by-session base. Therefore, even though the embodiment describes the use of a central database, the whole system can be distributed and connected through the internet. The database server comprises, for example two classes A and A′ with the following elements:

A={a1, a2, a3, b1}

A′={a1, a2, a3, b2}.

Class A can for example be defined by the user, while class A′ can be defined by a service provider. Generally, the elements of a class are defined “crisply”, which means that an element is a member of a class or the element is not a member of the class. The invention introduces a tolerance parameter that applies to the extensionally defined classes, thus those classes that are defined “by way of example”. Note, that an intensionally defined class can also exhibit this “by way of example” property, if, for example, it is defined in terms of a type or other class that itself is defined “by way of example”. A class definition “by way of example” concerns the use of so-called nominals, see “F. Baader et al, The Description Logic Handbook, Cambridge, 2003: the class is defined by enumerating its elements”. Now, the query of the user comprises the request to retrieve elements that are like the elements in class A.

The tolerance parameter states what the minimum percentage is of its membership that must be in a relationship with another class for that relationship to hold. The tolerance parameter can describe both a “subsumes” and a “subsumed by” relationship. The other class is usually also extensionally defined. Usually, there is a bound to the value range of the tolerance parameter. For example, in the case the tolerance parameter drops below 50%, a class can turn to be a subclass of two otherwise disjoint superclasses. This would introduce an inconsistency: the intersection of the superclasses is empty by definition, while at the same time there seems to exist a non-empty set that is in both superclasses.

In the above-described example, the tolerance parameter is 75%, which means that at least 75% of the elements must be in the equivalence or subsumption relation for that relation to apply to the class. The tolerance parameter can also be defined per class.

Within the next step S200, all classes present in the database are observed. Classes that are defined in both intensional and extensional form, for example through an AND construct, only the extensional part is considered. In the above-described example, Class A and Class A′ are observed within step S200.

Within step S202, the classes are compared with each other for shared elements. Classes A and A′ share elements a1, a2, and a3. Elements b1 and b2 are not shared. In the case the classes do not share elements, the method continues to step S224. In the case the classes do share elements, the method continues to step S204.

Within step S224 a DL reasoning strategy is applied to the classes and the method returns the query result to the user. The reasoning is applied on the complete, original set of classes and relations (the one prior to step S200). Since it was concluded in S202 that the classes do not share elements, the DL reasoning does not account for a subsumption (or equivalence) relation between the classes.

Within step S204, the shared elements are expressed relatively to the total number of elements enumerated in the class's definition. Within the example, both classes share 75% of their elements.

Within the next step S206, it is decided whether or not the sharing classes are in a subsumption relation with each other, based on the tolerance threshold. This is done in both directions; if for both classes it is concluded that they are related through subsumption, it is concluded that they are (fuzzy) equivalent. Since the threshold is 75% and 75% of the elements of Class A are shared with Class A′, Class A is fuzzy subsumed by Class A′. Further, since 75% of the elements of Class A′ are shared with Class A, Class A′ is fuzzy subsumed by Class A. Hence, Class A is fuzzy equivalent to Class A′.

If in step S206 it is decided that there are no additional relationships the method optionally continues with step S224.

Within the next step S208, the subsumption relation between the classes is added to the so-far ignored or empty intensional part. The addition and the further steps of the method are applied on the complete, original set of classes and relations (the one prior to step S200). Within the example, the equivalence relation is added:
A=A′

Now, either step S210 or step S212 is performed depending upon the reasoning strategy chosen.

Within step S210, every enumeration in the extensional definition parts is replaced with a, possibly new, name. This means, that the set of elements is replaced with the new class name. This new concept name denotes the extensionally defined part of the concept. Within DL, a distinction is made between so called TBox and ABox, see F. Baader et al, The Description Logic Handbook, Cambridge, 2003. In DL classes are referred to as concepts. The TBox describes relations between concepts and the ABox defines assertions over elements. A subsumption, or subclass relation, is a relation between concepts and the inference about these relations is denoted as TBox reasoning. The term “nominals” is used in the case concepts within the TBox are described as a list of elements, as used in the given example. Then, an ABox assertion is: an element from that list is an element of the concept. Replacing the enumeration with a new name, means that in the TBox the list is replaced by a new name:

{a1, a2, a3, b1} is replaced by B, which means that the TBox definition A={a1, a2, a3, b1} is replaced by A=B. Likewise {a1, a2, a3, b2} is replaced by B′, which means that the TBox definition A′={a1, a2, a3, b2} is replaced by A′=B′. Further all assertions like a1εA, b1εA, a2εA′ and b2εA′ are removed from the ABox.

Within the next step S214, regular DL reasoning is applied to infer the subsumption and equivalence relations over the complete database or knowledge-base, which is now preferably completely intensionally defined. Within the next step S220, the query result is returned to the user. The renaming in step S210 is recovered insofar renamed concepts are part of the query answer. For example, a user has defined A and a provider has created A′ as described above. The user asks for items like A with threshold 75%, i.e. for items that are in classes Q so that Q⊂A for at least 75%. After the above preprocessing the query is for items that are in classes Q so that Q⊂A holds exactly (for 100%). In the TBox it is found that A′⊂A (recall, the relation A=A′ was added) and hence A′ is a subset of Q. Items in A′ are B′, which stands for {a1, a2, a3, b2} and this set is returned to the user.

Within step S212, all outliers are removed from the enumerations:

Class A with elements: a1, a2, a3: A={a1, a2, a3, b1} is replaced by A={a1, a2, a3}. In the ABox only the assertion b1εA is removed.

Class A′ with elements: a1, a2, a3: A′={a1, a2, a3, b2} is replaced by A′={a1, a2, a3}. In the ABox only the assertion b2εA′ is removed.

Within the next step S216, DL-reasoning is applied to infer the subsumption and equivalence relations over the complete database or knowledge-base, which is possibly extensionally defined (at least for the A's and B's) or as a combination of both intensionally and extensionally.

Within the next step S218, the removed outliers are returned to their corresponding classes, to complete the answers to the query of the user that request the elements of these classes.

For the example above and reasoning as described in step S220, it holds that the items in A′ are {a1, a2, a3}, and b2 is added to the enumeration that is returned to the user in this step.

The process can be implemented as an off-line computation, i.e. as a pre-processing step or as an on-line computation. The procedure preferably removes the tolerance parameter, i.e. it removes the fuzzy logic part from the logic inferencing tasks, so that standard DL reasoners like FaCT and RACER, see “F. Baader et al, The Description Logic Handbook, Cambridge, 2003”, see also “http://www.cs.man.ac.uk/˜horrocks/FaCT/” and “http://www.sts.tu-harburg.de/˜ra.moeller/racer/”, which do not support fuzzy logic inclusion, can be used. The procedure allows users to enter their definitions based on example items, enabling them to formulate queries like “give me more like/comparable to these”. The search is assisted with reasoning based on known concept or semantic relations. In order to give the user more control over the threshold parameter, the threshold parameter can be configurable. Then, the user can for example set the parameter per query for all classes. Instead of the user, the content provider can control the threshold parameter. It is also possible that the reasoning strategy is extended to search, for example, for the smallest superset of classes that still adhere to the query etc. Further the classes need not be defined extensionally. For example, if Class A is defined extensionally with element “Bridge over troubled water”, the other class A′ can be defined intensionally as “songs from the 60s”. In a query requesting for “songs from the 60s”, the song “Bridge over troubled water” would not be retrieved, since it is a song from February 1970. However, with a threshold, the song could be retrieved in the case there are enough other songs defined within Class A that do belong to the 60s.

The order in the described embodiments of the method of the current invention is not mandatory, a person skilled in the art may change the order of steps or perform steps concurrently using threading models, multi-processor systems or multiple processes without departing from the concept as intended by the current invention. Further the method of the current invention can be distributed onto a computer readable medium having stored thereon instructions for causing one ore more processing units to perform this method. A computer readable medium is for example a Compact Disk (CD) Digital Versatile Disk (DVD), DVD+RW, BluRay etc. A processing unit is for example a microprocessor. The instructions can also be downloaded from a server via the internet or from a portable digital assistant (pda) or mobile phone using a wireless application protocol (wap) interface or other distributed devices.

FIG. 3 illustrates an embodiment of a system according to the invention in a schematic way. The system 300 comprises a database 302, a central processing unit (cpu) 304, memories 306, 308, and 312 and software bus 310. The database, cpu, and memories communicate with each other through software bus 310. The database 302 comprises definitions of the relations of the classes that are stored within the database. The memory 306 comprises computer readable and executable code that is designed to submit a query to the database as previously described. The memory 308 comprises computer readable and executable code that is designed to retrieve a query result from the database as previously described. The memory 312 comprises computer readable and executable code that is designed to apply the reasoning logic and the relations between the classes of the system as previously described. The system can for example be a personal computer, a personal digital assistant, a mobile phone etc. The user can submit the query to the system by operating an input device like a numeric keyboard, touch screen, stylus, mouse, voice recognition etc. The query can be presented to the user on an output device like a display or by, for example, playing or presenting the retrieved media file, like mp3, mpeg, jpeg, etc. The database can also be located remotely at a separate server that is connected to the system through the internet, or through a broadband connection, etc. The memories, database and cpu can also be connected through a network connection like an in-home network, the internet, etc. Further, other architectures can be used in stead of a client/server architecture. For example, a peer to peer architecture can be used.

It should be noted that the above mentioned embodiments illustrate rather than limit the invention, and that those skilled in the art will be able to design many alternative embodiments without departing from the scope of the appended claims. For example, instead of DL reasoning other reasoning systems can be used. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. Method of retrieving a plurality of information items from a data storage, the method comprising:
submitting a request to the data storage, the request comprising a general classification;
retrieving the plurality of information items of which at least a predefined amount of the plurality of information items complies with the general classification, the general classification defining a first class, and the plurality of information items are elements of a second class and there exists a relation between the first and second class.

2. Method according to claim 1, wherein the elements of the second class and/or first class are defined extensionally by enumerating each information item of the plurality of information items.

3. Method according to claim 1, the method comprising
removing information items that do not comply with the general classification from the second class;
annotating the removed information items as being related to the second class;
applying reasoning rules to the first and second class based upon the request to the data storage;
retrieving the plurality of information items of which at least a predefined amount of the plurality of information items complies with the general classification.

4. Method according to claim 1, wherein the plurality of information items is a subset of a second plurality of information items implies that at least a predefined amount of the plurality of information items is a subset of the second plurality of information items.

5. Method according to claim 1, wherein the predefined amount is one of a percentage of the plurality of information items or an absolute number of the plurality of information items.

6. Method according to claim 3, wherein the predefined amount of information items is complemented with the annotated removed information items.

7. Method according to claim 3, wherein the second class is being annotated as having removed information items

8. Method according to claim 1, the method comprising removing information items that do not comply with the general classification from the first class.

9. System (300) for retrieving a plurality of information items, the system comprising:
a data storage; and
a programmable processor configured to:
submit a request to the data storage, the request comprising a general classification;
define a first class and a second class, wherein the general classification defines the first class, and wherein the plurality of information items are elements of the second class and there exists a relation between the first and second class; and
retrieve the plurality of information items of which at least a predefined amount of the plurality of information items complies with the general classification.

10. System according to claim 9, wherein the system is a distributed system.

11. Computer program stored on a computer readable medium, the computer program, when executed, comprises:
submitting a request to a data storage, the request comprising a general classification;
retrieving a plurality of information items of which at least a predefined amount of the plurality of information items complies with the general classification, the general classification defining a first class, and the plurality of information items are elements of a second class and there is a relation between the first and second class.

12. (canceled)

13. System according to claim 9, wherein the data storage is a distributed data storage.
